(19) United States
(12) Patent Application Publication
(10) Pub. No.: US 2015/0200022 A1
(43) Pub. Date: Jul. 16, 2015

(54) CONTAINMENT PROTECTION SYSTEM FOR A NUCLEAR FACILITY AND ASSOCIATED OPERATING METHOD

(71) Applicant: AREVA GMBH, ERLANGEN (DE)

(72) Inventors: AXEL HILL, STOCKSTADT (DE); NORBERT LOSCH, OFFENBACH (DE)

(21) Appl. No.: 14/611,559

(22) Filed: Feb. 2, 2015

Related U.S. Application Data
(63) Continuation of application No. PCT/EP2013/063153, filed on Jun. 24, 2013.

(30) Foreign Application Priority Data
Aug. 1, 2012 (DE) 102012213614.2

(51) Int. Cl. G21C 13/02; G21C 19/28; G21C 9/004

(52) U.S. Cl. CPC G21C 13/022; G21C 9/004; G21C 19/28

(57) ABSTRACT

A containment protection system for treating air in a containment of a nuclear facility in the case of accidents involving extensive release of hydrogen and steam is to be able to effectively relieve such conditions in a largely passive manner. Accordingly, the containment protection system has for a circuit, which contains a conduction system and is provided for connecting to the containment, out of the containment and back again for a fluid flow. The system has a recombination device for recombining hydrogen contained in the fluid flow with oxygen to form steam, a condensation device connected downstream of the recombination device for condensing steam fractions contained in the fluid flow with measures for diverting the condensate out of the fluid flow, and a drive device for the fluid flow. A heat exchanger at least partial re-cools the condensation device.

### CROSS-REFERENCE TO RELATED APPLICATION

This is a continuation application, under 35 U.S.C. §120, of copending international application No. PCT/EP2013/063153, filed Jun. 24, 2013, which designated the United States; this application also claims the priority, under 35 U.S.C. §119, of German patent application No. DE 10 2012 213 614.2, filed Aug. 1, 2012; the prior applications are herewith incorporated by reference in their entireties.

### BACKGROUND OF THE INVENTION

### Field of the Invention

The invention relates to a containment protection system for treating the atmosphere located in the containment of a nuclear facility, in particular of a nuclear power plant, in the event of critical incidents entailing an extensive release of hydrogen and steam. The invention relates, furthermore, to a method for operating a system of this type.

In the event of a serious incident in a nuclear facility, in particular a nuclear power plant, not only is steam released, but there is also a release of large quantities of hydrogen, particularly due to the known zirconium/water reaction on superheated fuel rod cladding tubes. Without countermeasures, explosive (even detonation-susceptible) mixtures, which in the event of an uncontrolled reaction put at risk the integrity of the safety enclosure usually designated as a containment, cannot be ruled out.

Furthermore, particularly with regard to smaller inertised boiling water reactor containments (with a volume of about 5,000 to 15,000 m³), the release of non-condensable hydrogen, together with steam, results in a rapid pressure rise which may exceed the design pressure of the safety containment and amount to a failure pressure.

Hitherto, in some instances, the containment has been equipped as an effective countermeasure with a system for a filtered pressure relief (venting). In this case, however, release into the surroundings occurs. Even though the discharge of radioactivity is exceedingly low when modern purification and filtration concepts are adopted, this behavior is basically undesirable.

Inside the containment of pressurized water reactor facilities, there are often what are known as passive autocatalytic recombinators (PARs) which, however, in inertised boiling water reactor facilities, lose their hydrogen breakdown function after the oxygen necessary for the recombination reaction is spent. In the predominant part of boiling water reactor facilities of the older type of construction, the installed hydrogen breakdown systems are conceived only for design incidents of a low to medium degree of severity, and therefore their breakdown capacity is not sufficient for serious incidents up to and including core meltdown scenarios.

### SUMMARY OF THE INVENTION

The object of the present invention is to specify a containment protection system which avoids the disadvantages of previous solutions and is capable, even in the case of inertised containments, of effectively and quickly breaking down excess pressure states and critical accumulations of hydrogen in a predominantly passive way and, as far as possible, without polluting the surroundings. Furthermore, an especially advantageous method for operating a system of this type is to be specified.

By means of the containment protection system according to the invention, the hydrogen in the containment can be broken down in a short time and also excess pressure failure of the containment due to the release of steam and of large hydrogen quantities can be prevented, without a release of radioactive materials into the surroundings occurring.

By means of the combined method of recuperative high-speed multistage oxidation and an integrated purification stage/scrubber unit with steam condensation, the hydrogen and steam concentration in the containment can be dealt with, while at the same time pressure is lowered.

For this purpose, the system is connected in a circuit to the containment, so that there is no intentional release of fission products during operation. Hydrogen recombination with oxygen into steam and the condensation of the latter result in a rapid lowering of pressure in the containment. This lowering of pressure is reinforced in that the steam located in the containment is likewise condensed in the purification stage. In the scrubber stage, activity is collected and can be fed back from this into the pressure-carrying surround of the containment in a directed manner or be delivered to a plant for the treatment of radioactive wastewaters.

Essential advantages of the system according to the invention can be summarized as follows.

The system can operate without any radioactive emission of fission products into the surroundings.

Alternative filtered pressure relief is possible at any time, in order to rule out reliably at any time the failure of the safety containment.

The reactor building can be inertised by means of the nitrogen used as coolant during steam condensation, in order to prevent ignition caused by hydrogen leakages outside the containment.

Particularly with regard to inertised boiling water reactor containments, excess pressure failure of the safety containment can be prevented, and at the same time the hydrogen problem can be solved without any emission into the surroundings.

Old facilities which are still running can, in terms of the problems outlined, be raised to the safety level of the facility design of a more recent generation (GEN3+).

The retrofitting of old facilities, in particular mobile use in emergencies, is assisted by the container-type modular set-up.

Owing to the recuperative character and the logical utilization of energy present in the containment in the event of a critical incident, the system manages with a small amount of external auxiliary electrical energy and operates in a largely passive manner.

Auxiliary electrical energy can easily be provided by rechargeable batteries, if appropriate in conjunction with small mobile diesel emergency power generators, fuel cells or the like.

Other features which are considered as characteristic for the invention are set forth in the appended claims.

Although the invention is illustrated and described herein as embodied in a containment protection system for a nuclear facility and associated operating method, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is an illustration showing a first variant of a containment protection system for pressure breakdown and for hydrogen breakdown in a containment of a nuclear facility in the event of critical incidents according to the invention;

FIG. 1A is a diagrammatic, cross-sectional view of a reaction chamber;

FIG. 2 is an illustration showing a boiling water reactor with a connected containment protection system according to FIG. 1;

FIG. 3 is an illustration showing a second variant of a containment protection system;

FIG. 4 is an illustration showing a third variant of a containment protection system; and

FIG. 5 is an illustration showing a fourth variant of a containment protection system.

### DETAILED DESCRIPTION OF THE INVENTION

Identical or identically acting parts are given the same reference symbols in each case.

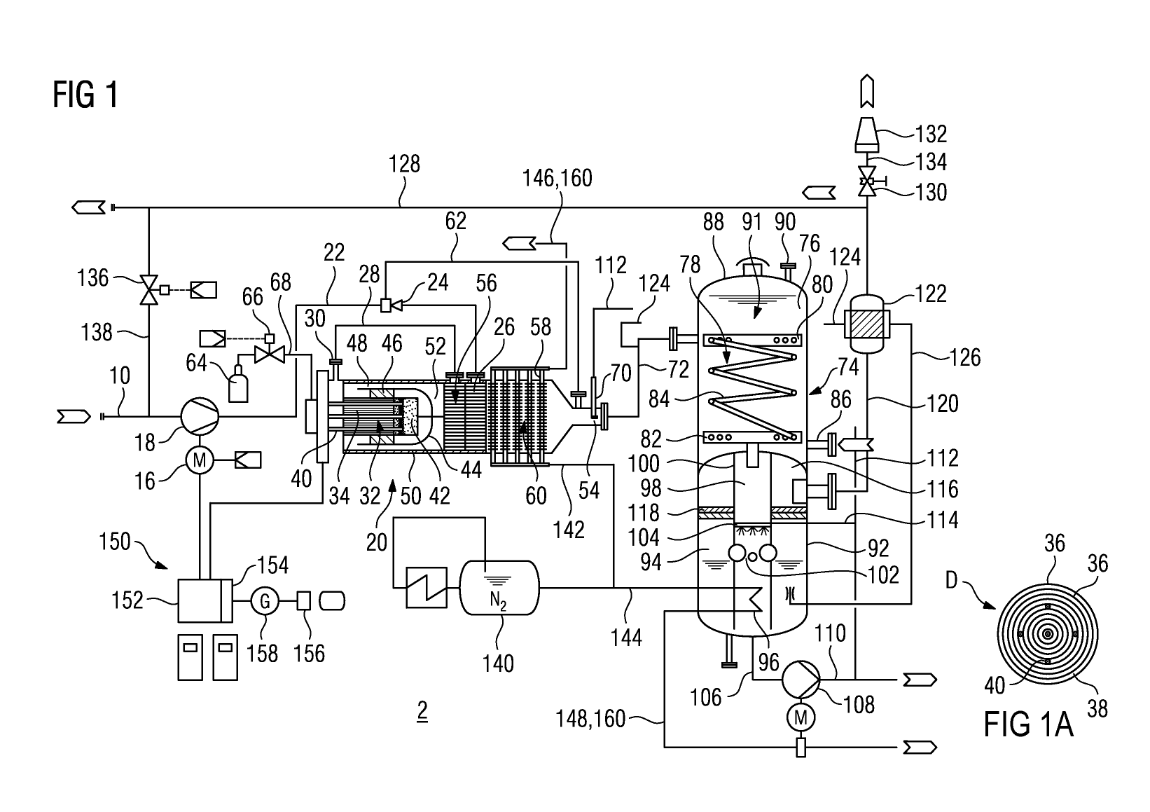

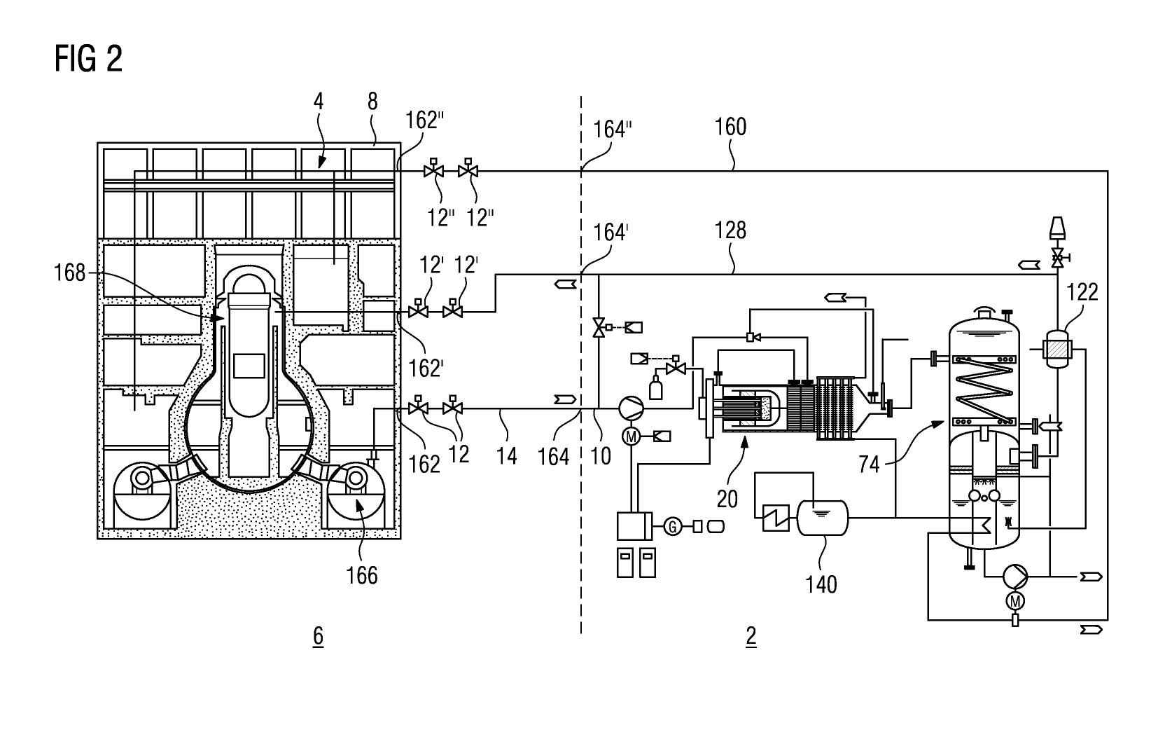

Referring now to the figures of the drawings in detail and first, particularly to FIGS. 1 and 2 thereof, there is shown a containment protection system 2 (in brief, protection system) which serves for treating the atmosphere located in a containment 4 of a nuclear facility 6, in particular of a nuclear power plant, above all in the event of critical incidents and accidents entailing an extensive release of hydrogen H₂ and/or steam. The object of the protection system 2 is, inter alia, to break down excess pressure states occurring in the event of such accident scenarios in the inner space, designated as the containment 4, of a safety containment 8 and to break down ignitable accumulations of hydrogen H₂ by recombination with oxygen O₂ and/or, if appropriate, render them uncritical by inertising.

For this purpose, the protection system 2 according to FIG. 1, located with its essential components outside the safety containment 8, contains a supply line 10 which is connected (see also FIG. 2) to an associated outflow line 14 which is led out of the safety containment 8 of the nuclear facility 6 and can be closed by means of a shut-off valve 12 and which is also designated as a pressure relief line (see also FIG. 2).

A conveying blower 18 operated, for example, with the aid of an electric drive motor 16 is connected into the supply line 10. As stated in more detail further below, the conveying blower 18 may also be arranged further downstream in the line system carrying the fluid stream. The conveying blower 18 conveys the gas/steam mixture, which is present in the containment 4 and may possess a pressure of, for example, >1 bar to 10 bar at the start of the relief operation, to a downstream recombination device 20 which is designed for the catalytically assisted and flameless breakdown of hydrogen H₂ contained therein. Here, in FIG. 1, the recombination device 20 is configured as a combined multistage recombination and cooling device. The gas/steam mixture which, in relief operation, flows out of the containment 4 through the outflow line 14 and the supply line 10, is hereafter also designated as a fluid stream or, with reference to what are known as venting systems, also as a vent stream, even though, in the protection system 2 according to FIG. 1, there does not necessarily have to be venting in the actual sense, along with release into the surroundings.

First, the fluid stream which is supplied via the line section 22 and is to be treated runs through a Venturi tube 24 or similar nozzle of the convergent/divergent type and is at the same time accelerated to flow velocities of up to 160 m/s, measured at the neck of the Venturi tube 24.

Subsequently, that is to say downstream, the fluid stream runs through a recuperative pre-heater 26, in which it is preheated by the transition of heat from the fluid stream (exhaust gas stream) heated as a result of the downstream catalytic reaction. In the present case, the pre-heater 26 is designed as a U-shaped pipeline with only minor flow losses for the fluid stream.

The preheated fluid stream then passes via the line 28 and the inlet connection piece 30 into the reaction chamber 32 of the recombination device 20 active as an oxidation device and runs through a first reaction zone 34, designated also as an electrothermal recombinator, which is heated electrically and in which a flameless recombination of hydrogen H₂ contained in the fluid stream and oxygen O₂ into steam H₂O takes place. The electrically initiated reaction is transferred in a domino effect to the surrounding concentrically arranged reaction zones (see further below).

By the reaction heat occurring during H₂ recombination, the electrical heating capacity can be gradually cut back after start-up operation, without the reaction taking place being interrupted. The higher the H₂ concentration is, the higher the throughput can be set by the appropriate power regulation of the conveying blower 18 (what is known as sliding throughput operation).

The flow path within this process component is defined by a plurality of cylindrical-surface-shaped carrier elements 36 which are arranged concentrically about a common longitudinal axis and are in each case provided on their inner and outer surface with a coating catalytically active in terms of hydrogen recombination, as may be gathered from the detail D depicted in cross-sectional illustration of FIG. 1A. The carrier elements 36 are typically made from metal or from ceramic or from a composite material containing metallic and/or ceramic constituents. The catalytically active coating of the carrier elements 36 usually contains platinum, palladium, vanadium and/or other suitable noble metals.

At least in one of the flow-carrying interspaces 38 formed in this way, alternatively or additionally in the carrier elements 36, bar-shaped electric heating elements 40 oriented parallel to the longitudinal axis are arranged, specifically preferably so as to be distributed uniformly over the circumference. An electric heating element 40 or heating bar of this type can also be arranged in the central interspace. Overall, therefore, as uniform a heating as possible of the flow duct, subdivided by the carrier elements 36, of the first reaction zone 34 over the longitudinal extent and also over the entire cross-section is achieved, in order thereby to initiate and assist the catalytic reaction even with a comparatively high flow velocity and a correspondingly short dwell time of the fluid stream in the first reaction zone 34.

Directly after the first reaction zone 34, that is to say downstream, extends a second reaction zone 42, through which the fluid stream flows and which is configured in a manner of a loose-material or fluidized-bed catalyst known from exhaust gas technology and which contributes to the catalytic recombination of hydrogen and oxygen fractions still not picked up by the first reaction stage 34.

The fluid stream emerging from the second reaction zone 42 is forced into a reversal of direction at a surrounding wall 44, of dome-like shape in this section, of the reaction chamber 32 and finally runs through a third reaction zone 46 of annular cross-section, which is delimited inwardly by the flow duct of the first reaction zone 34 and outwardly by the surrounding wall 44, in the form of a cylindrical surface in this section, of the reaction chamber 32.

A third reaction zone 46 serves for the catalytic retreatment of the fluid stream, pretreated by the first two reaction zones 34 and 42, in terms of residual constituents still to be recombined on the principle, known per se, of passive autocatalytic recombinators having carrier elements with low pressure loss (which are known as PARs). Owing to the casing-like configuration of the third reaction zone 46 around the first reaction zone 34, a transmission of heat from the inside outward takes place, so that the third reaction zone 46, too, is heated indirectly by the heating elements 40 arranged in the first reaction zone 34 and by the heat released there as a result of the exothermal oxidation reaction.

After renewed reversal of direction at the left end phase of the reaction chamber 32, the fluid stream, treated in the three successive reaction zones 34, 42 and 46 and depleted with regard to hydrogen concentration, first flows through a region 48 of annular cross-section between the surrounding wall 44 of the reaction chamber and the cylindrical-surface-shaped surrounding wall 50 of the outer flow duct 52, surrounding it, to the right toward its outlet connection piece 54.

In this case, the gas/steam mixture heated as a result of the multistage recombination reactions and due to the action of the electric heating elements 40 and flowing out of the reaction chamber 32 flows past the heat exchanger surfaces of the pre-heater 26 active as a heat exchanger 56, where it gives off parts of its heat content in the way already described above to the gas/steam mixture flowing into the reaction chamber 32.

Further downstream in the flow duct 52, the gas/steam mixture (exhaust gas) depleted with regard to its hydrogen concentration flows past the heat exchanger surfaces, through which a coolant, here nitrogen N₂ (see further below), flows, of a heat exchanger 58 in the cooling zone 60 and at the same time transfers a further part of its remaining heat content to the coolant. For especially effective cooling, the coolant, when it enters the heat exchanger 58, is at least partially liquid and is at least partially evaporated as a result of the transfer of heat from the gas/steam mixture flowing in the flow duct 52. On account of the given temperature conditions and system design, appreciable condensation of steam constituents, in particular of steam as a product of the recombination reaction, which are contained in the gas/steam mixture does not yet take place in this case. The cooling zone 60 therefore acts merely as a gas cooler, not as a condenser. Typical temperature values of the flow medium lie, directly upstream of the cooling zone 60, in the range of 600 to 800° C. and, thereafter, in the range of 250 to 500° C.

On the outlet side, here downstream of the cooling zone 60, the flow duct 52 has connected to it a recirculation line 62, the other end of which issues into the line section 22 leading to the pre-heater 26, in order thereby to return a part quantity of the depleted fluid stream, flowing out of the recombination device 20, to its inlet side and to mix it with the enriched fluid stream coming from the containment 4. More specifically, the other end of the recirculation line 62 issues in a feed port arranged at the neck of the Venturi tube 24, so that the returned part stream is entrained (ejector principle, see further below) as a result of the suction action occurring there. Owing to the integrated exhaust gas recirculation and associated partial inertising of the reaction stages or reaction zones 34, 42 and 46, even high hydrogen concentrations (up to 30% by volume or more) in the fluid stream led out of the containment 4 can be dealt with for rapid breakdown of hydrogen.

To set or regulate the returned part stream, a corresponding regulating valve (not illustrated) may be present in the recirculation line 62 and/or in the feed port to the Venturi tube 24. In this case, typically, it is desirable as a regulation target to maintain a steam fraction of >50% in the inlet stream of the recombination device 20.

In the case of inertised containments 4, a regulated feed of oxygen O₂ takes place upstream of the recombination device 20 out of a suitable reservoir, here out of a pressure vessel, also designated as an oxygen bottle 64, which is filled with pressurized oxygen O₂. To set or regulate the feed rate, a regulating valve 66 is provided in the connecting line 68 which here issues directly into the reaction chamber 32. By the H₂/O₂ concentration in the inlet stream of the recombination device 20 being measured, the required oxygen quantity for a stoichiometric combustion is determined, and the oxygen quantity to be fed is set via the regulating valve 66.

Downstream of the connection for the recirculation line 62, at that end of the flow duct 52 which is opposite the reaction chamber 32, is arranged a spray-in device 70 for spraying in or injecting a liquid, here essentially water, which occurs (see further below) as condensate in the following process stages. Thus, further cooling of the fluid stream carried in the flow duct 52 is implemented in a manner of injection cooling. The spray stream is preferably permanently set for the sake of simplicity.

Although the configuration, described here, of the recombination device 20 as a combined multistage recombination and cooling device is especially advantageous for the intended purpose, nevertheless, in principle, other, in particular more simply constructed recombination devices, for example of the single-stage type and/or with lower design flow velocities, may also be used. The cooling stages integrated into the flow duct 52 may, if appropriate, be dispensed with or be implemented in another way. In other configurations, the preceding Venturi tube may be dispensed with, and likewise the exhaust gas recirculation via the recirculation line 62.

The depleted and cooled fluid stream emerging on the right end phase of the flow duct 52 passes via the line 72 into a condensation device 74 which is configured here advantageously as a combined condensation and scrubber device. The actual condensation stage, in which the phase transition of the condensable fraction of the fluid stream from gaseous to liquid takes place, is expediently preceded by a (pre-) cooling stage which is preferably likewise integrated structurally into the overall unit.

Located in the upper part of the overall essentially upright cylindrical arrangement is a ring cooler 78, surrounded by cooling liquid 76, here water H₂O, for cooling the fluid stream to approximately condensation temperature in respect of steam fractions contained therein, in particular of steam released during the preceding recombination reaction, but also of steam already released previously in the containment 4. The ring cooler 78 has an inlet header 80 and outlet header 82 which are connected to one another via intermediate spiral tubes 84 flow-connected in parallel and active as heat exchangers. The water H₂O serving for cooling is extracted, for example, from the local water network (firefighting connection, etc.) and is fed, as required, via a fresh water connection 86 into the cooling liquid container 88 surrounding the ring cooler 78. Water heated and evaporated during the cooling operation is discharged as steam into the surroundings via a steam outlet 90. The cooling device 91 formed overall in this way is also designated in brief as a cooler or (pre-) cooling stage. The temperature of the fluid stream typically lies, directly upstream of the cooler, in the range of 200 to 500° C. and, thereafter, in the range of 100 to 200° C., depending on the pressure in the system.

The fluid stream cooled further in this way passes over via the outlet header 82 into the condensation container 92 which is arranged underneath the cooling liquid container 88 and in which the condensation of the steam fractions takes place as a result of further cooling. The liquid condensate 94 collects at the bottom of the condensation container 92. The recooling required for condensation takes place at least partially via a separate coolant, here nitrogen N₂, which is routed (see further below) through tube bundles or the like projecting into the condensate 94 and active as heat exchangers 96. For especially effective cooling, the coolant, when it enters the heat exchanger 96, is at least partially liquid and is evaporated as a result of the transfer of heat from the condensate 94. Thus, when nitrogen is used, both the heat exchanger 96 and the heat exchanger 58 may be designated as nitrogen evaporators.

Additionally or alternatively to the recooling of the condensation container 92 brought about by nitrogen evaporation (in general: inert gas evaporation), recooling by cooling water evaporation may also be provided, for example with the aid of heat exchangers which are mounted in/or the condensation container 92 and through which cooling water flows and/or by the cooling device 91 which is spatially directly adjacent and is active as a heat sink. In general, the system configuration is preferably such that the cooling of the fluid stream takes place primarily by cooling water evaporation and secondarily by nitrogen evaporation, inter alia in order to keep nitrogen consumption therefore the necessary stock within justifiable limits.

In the variant illustrated in FIG. 1, at the same time as the fluid stream, to be condensed with regard to its steam constituents, enters the condensation container 92, purification of the non-condensable gas fractions takes place. For this purpose, the inlet region 98 is configured in the manner of a Venturi scrubber. The fluid stream is routed within a centrally arranged cylindrical flow duct 100, in a similar way to the neck of a Venturi tube, via a contraction 102 configured, for example, as an annular slit or as a diaphragm-like orifice and passes further down into the condensate 94 which is forming. In the region of the contraction 102 or shortly upstream of this, as seen in the flow direction, a spray-in device 104 for a liquid may be arranged. For this purpose, expediently, the condensate 94 itself which collects in the condensation container 92 is used. The spray stream is preferably set permanently for the sake of simplicity. As a result of the intensity of swirling and fragmentation of the fluid stream in the region of the contraction 102 and due to intermixing with spray liquid and also because the non-condensable gas constituents are routed through the collecting condensate 94, the radionuclides and iodine contained in the fluid stream are deposited into the condensate 94.

The radioactively laden condensate 94 accumulating in the condensation container 92 during relief operation is drawn off discontinuously or continuously, as required, via a condensate extraction line 106 which is connected to the bottom of the condensation container 92 and into which a condensate pump 108 is connected. A filling-level control acting upon the condensate pump 108 ensures that the level of the condensate 94 in the condensation container 92 does not exceed a stipulated maximum value. Since the excess condensate 94 is for the most part or completely pumped back into the containment 4 of the nuclear facility 6 via a condensate return line 110, the activities contained therein are also delivered in a directed manner for secure storage. In other words, activity is retained in a directed manner in the purification stage so that it can be conveyed back again from here into the containment 4 in a directed manner. By the condensate being sprayed into the containment 4, a cooling action is also generated there and has in turn an advantageous effect upon the pressure, that is to say leads to a lowering of pressure.

From the condensate return line 110, a line 112 and a line 114 branch off, via which, as required, a first part stream of the condensate can be conducted to the spray-in device 70 and/or a second part stream can be conducted to the spray-in device 104. For the on-demand setting of the condensate streams, corresponding regulating valves may be present in the lines.

The non-condensable gas fractions pass out of the condensate 94 into the gas collecting space 116, lying above it, of the condensation container 92, at the same time passing through filter elements 118 arranged in the flow path. The filter elements 118 serve, in a first stage, as drop separators and, in a second stage or layer, for the separation of fine aerosols. Separation is important especially when a vent stream is discharged into the surroundings (see further below).

Via the line 120 connected to the gas collecting space 116, the cooled and pre-purified gas is delivered to a further filter device in the form of what is known as a molecular screen 122 which may also be integrated structurally into the condensation container 92 or, in general, into the condensation and scrubber device. The molecular screen 122, constructed, for example, on the basis of zeolite filters and operating on the chemical absorption principle, brings about, above all, a retention of organic iodine compounds (what is known as organoiodine), even when particle sizes are comparatively small.

For proper efficient operation without the risk of destruction of the moisture-sensitive filter-active constituents, the molecular screen 122 is heated, specifically preferably in a recuperative way. For this purpose, there branches off from the line 72 a line 124 for the extraction of the fluid stream which is still relatively hot there and which is routed past the molecular screen 122 for heat transmission. The extraction stream is conducted further downstream via the line 126 into the condensate 94 present in the condensation container 92.

The purified and filtered gas stream flowing out of the molecular screen 122 is, as a rule, returned completely into the containment 4 via the recirculation line 128. In this circuit operation, therefore, there is no emission into the surroundings (zero release/zero emission).

For emergencies only, there branches off from the recirculation line 128 an outflow line 134 which is provided with a shut-off valve 130 and issues, for example, in a chimney 132 and via which the previously purified and filtered gas stream can be discharged into the surroundings in the manner of conventional venting. Thus, at any time, filtered rapid pressure relief to a lower pressure level can also be carried out in the containment 4, with emission into the surroundings, and subsequently circuit operation (zero release) for minimizing radioactive discharge into the surroundings can be performed.

Via a connecting line 138, normally closed by a shut-off valve 136, between the supply line 10 and the recirculation line 128, a part quantity of purified and filtered low-hydrogen gas can be transferred, as required, directly, without detouring via the containment 4, into the hydrogen-rich fluid stream to be treated. The inlet stream to the conveying blower 18 is thereby inertised.

For the recooling of the condensation and scrubber device 74, in particular as a condensation container 92, and, if appropriate, also for the previous cooling of the fluid stream in the cooling zone 60, a reservoir 140 thermally insulated with respect to the surroundings and having liquid nitrogen N₂ as coolant, is provided (volume typically 10,000 to 20,000 m³), which is connected via corresponding lines 142 and 144 to the associated heat exchangers 58 and 96, in which the nitrogen N₂ evaporates by the absorption of heat, as already illustrated above. In the design variant illustrated here, the evaporated nitrogen is routed via lines 146 and 148 into the containment 4 or into the reactor building. Inertising of the atmosphere inside is thereby brought about, in order to prevent the situation where a leakage of hydrogen H₂, which is not overcome or not sufficiently quickly overcome by building-internal recombinators leads to uncontrolled ignition there.

If not all the nitrogen N₂ is to be introduced into the containment 4 or reactor building, the excess fraction can be discharged into the surroundings via an outlet orifice, not illustrated here, in the lines 146 and 148.

Liquid nitrogen is available comparatively cost-effectively and is therefore preferred as a coolant and/or inertising agent. Alternatively or additionally, however, liquid carbon dioxide (CO₂) may also be used for this purpose. Wherever nitrogen is referred to in the text, therefore, carbon dioxide or nitrogen/carbon dioxide or, more generally, inert gas could stand, as far as this is susceptible to effective cooling and/or condensation and also compact storage in this state.

The containment protection system 2 is equipped with an independent uninterrupted power supply unit 150, preferably with a rechargeable battery 152 or an accumulator, for reliable starting and immediate delay-free operation even in serious incident scenarios, including station blackout and LOOP (=Loss Of Offsite Power). The power source supplies, in particular via electrical lines, the drive motor 16 of the conveying blower 18 and the electric heating elements 40 of the recombination device 20 with electrical current. In one possible variant, it also supplies the condensate pump 108 with electrical current. Long-term system availability is ensured by a charging unit 154 for the rechargeable battery 152, preferably with a generator 158 driven by an internal combustion engine 156 (for example, diesel engine).

The containment protection system 2 is preferably implemented in a modular type of construction. For this purpose, the individual system units or modules are configured in container dimensions so as to be transportable by road and by air. The system can therefore be used for a permanent installation of the container type or in a mobile manner. For example, the condensation and scrubber device 74, including the molecular screen 122, forms a module of this type, as does the multistage recombination and cooling device 20. The power supply unit 150 can be accommodated, together with a control or regulating device for the overall facility, in a further module. The reservoir 140 for the liquid nitrogen N₂ finally forms a further module which, after the stock is spent, can be exchanged for an identical module filled up in readiness for operation. The individual modules are expediently coordinated with one another in terms of their line connections and interfaces, etc., so that the required connections can be made easily and without the risk of confusion.

The nuclear facility 6 itself merely has to be equipped superficially with suitable connections, to which the supply line 10 for the pressure relief fluid stream, the recirculation line 128 for the purified gas stream and the feed line 160 for the nitrogen N₂ provided for inertising can be connected after the modules arranged outside the containment 4 have been set up. This precondition can be implemented or retrofitted comparatively simply even in the case of old facilities.

This is illustrated diagrammatically in FIG. 2. The part on the left of the vertical dashed line represents a nuclear power plant as an example of a nuclear facility 6 with a jacket-like safety containment 8 made from high-strength thick-walled steel which shields the inner space, also designated as a containment 4, hermetically with respect to the external surroundings. The safety containment 8 is equipped with a number of permanently installed leadthroughs 162, 162′ and 162″ for the various flow-carrying lines which are provided on the outside with shut-off valves 12, 12′ and 12″ (in each case connected in series in pairs). Even further outside, represented here by the dashed vertical line, the lines led out of the containment 4 through the safety containment 8 have connection pieces 164, 164′ and 164″ for the associated lines of the containment protection system 2 erected, as required, on the right of the dashed line, so that, after erection and the connection of line sections assigned to one another, overall, the above-mentioned lines—supply line 10, recirculation line 128 and inert gas feed line 160—are implemented.

As can be seen, furthermore, from FIG. 2 for the boiling water reactor illustrated as an example, in this case the extraction of the vent stream preferably takes place in the region of the annular condensation chamber 166, recirculation of the purified gas stream takes place in the region around the reactor pressure vessel 168 and the feed of nitrogen takes place in subspaces arranged further outside.

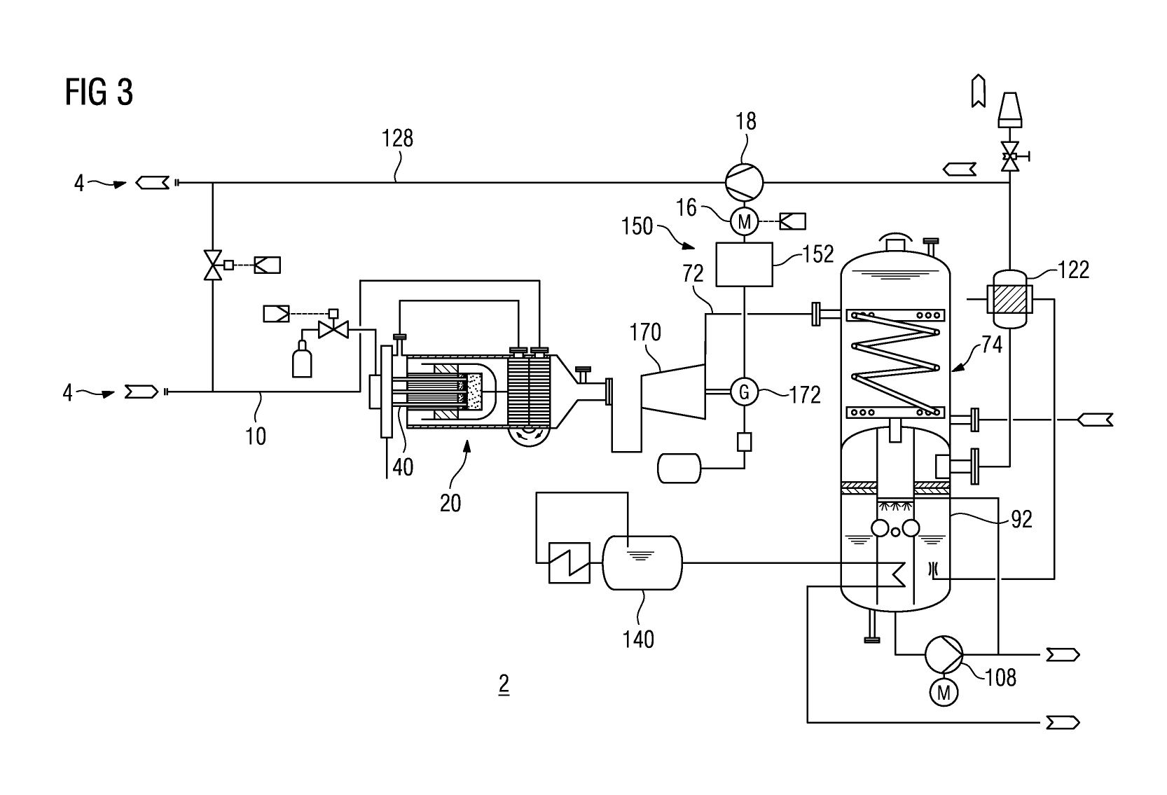

The variant, illustrated in FIG. 3, of the protection system 2, is constructed in terms of its essential components in a similar way to the variant illustrated in FIG. 1, and therefore only the differences need to be dealt with at this juncture.

In the first place, some optional equipment features have been omitted, such as, for example, exhaust gas recirculation, nitrogen cooling and condensate spray-in in the recombination device 20. These may, of course, still be present individually or altogether.

An essential modification in relation to the variant discussed above is that the conveying blower 18 is not arranged in the supply line 10 for the hydrogen-rich fluid stream from the containment 4, that is to say upstream of the recombination device 20, but instead in the recirculation line 128 for the low-hydrogen purified gas stream downstream of the condensation container 92 and of the molecular screen 122. The advantage of this is that the hydrogen H₂ initially carried along with the fluid stream has already been broken down in the recombination device 20, and the steam which has occurred in this case has been condensed and separated, together with other steam fractions, in the condensation device 74 when the remaining gas stream enters the conveying blower 18. The pressure drop generated passively in the condensation device 74 as a result of steam condensation is sufficient for transporting the fluid stream as far as the conveying blower 18. The conveying blower 18 then serves, above all, for conveying the remaining non-condensable gases back into the containment 4 again. This has a beneficial effect upon the dimensioning of the blower power and upon power/energy consumption. This variant could also be implemented independently in the protection system 2 according to FIG. 1.

In the protection system 2 according to FIG. 3, there is a further modification, which is combined with it, but which could also be implemented independently in the protection system 2 according to FIG. 1, in that a steam turbine 170 which is driven by the expanding fluid stream and drives a generator 172 is connected into the line 72 between the recombination device 20 and the condensation and scrubber device 74.

The electrical voltage picked off at the terminals of the generator 172 is utilized, after rectification, for charging the battery 152 of the power supply unit 150 which, in turn, supplies the drive motor 16 of the conveying blower 18 and the heating elements 40 of the recombination device 20 with current. Thus, the enthalpy gradient of the steam superheated as a result of hydrogen recombination is utilized in order, via the intermediate step of conversion into electrical energy and intermediate storage, to convey the non-condensable gases from the condensation and scrubber device 74 back into the containment 4. The rechargeable battery 152 therefore only has to be charged externally in order to start the process and is then recharged independently in relief operation. The overall system is consequently designed for a largely passive type of operation, without the use of external electrical energy.

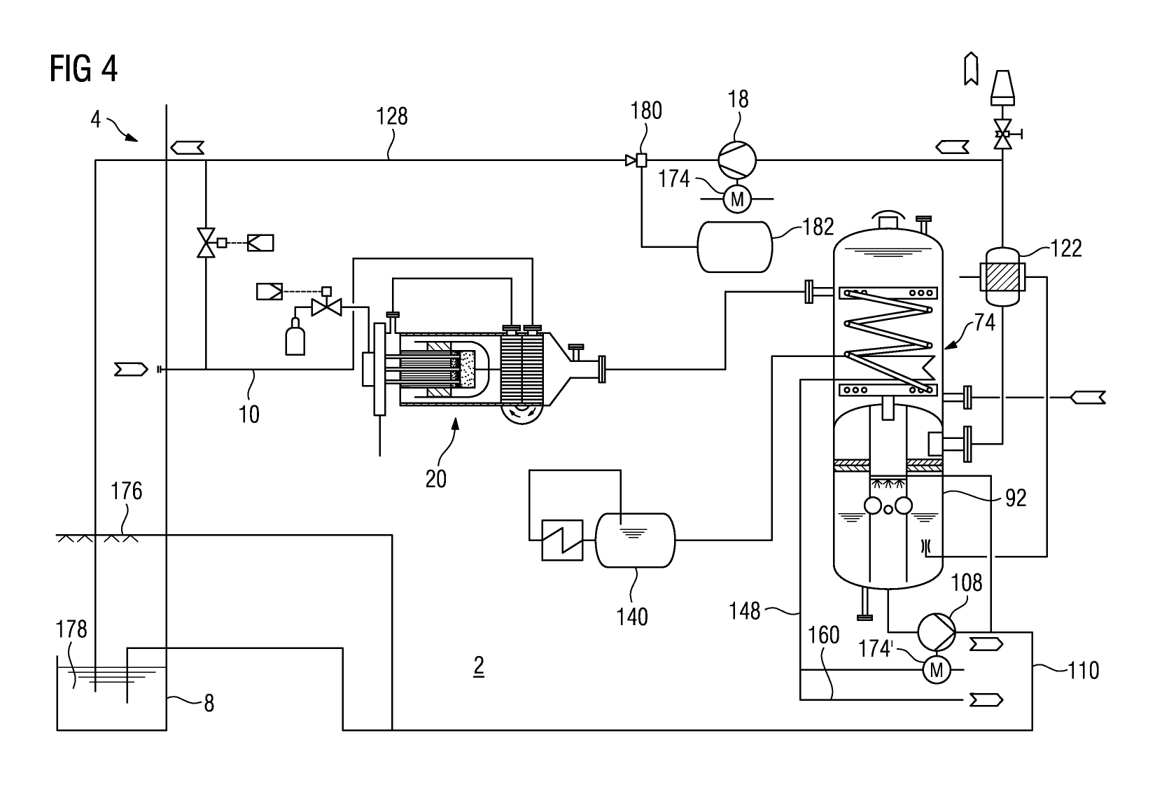

Further variations of the protection system which are able to be combined in many different ways with the variants described hitherto are illustrated in FIG. 4.

A particular feature of the protection system 2 illustrated here is that the expansion enthalpy of the nitrogen N₂ evaporated passively in the condensation and scrubber device 74 or in the cooling stage 60 is utilized for driving a gas engine 174 of the expansion gas engine type. The gas engine 174 then drives preferably directly, that is to say without the detour of conversion to electrical energy, the conveying blower 18 which is arranged in the recirculation line 128 and by which the non-condensable gases are fed back into the containment 4.

Additionally or alternatively, the condensate pump 108 may be driven in the way described by the same or a further expansion gas motor 174′. Alternatively, in all the variants, if the installation height is appropriately selected, feedback of the condensate 94 accumulating the condensation container 92 into the containment 4 by a geodetic gradient may be provided.

In general, when a condensate pump 108 is used, the condensate 94 in the containment 4 is sprayed with the aid of a spraying device 176 in order thereby to bring about cooling of the containment atmosphere.

Furthermore, the recirculation of the condensate into the sump 178, filled with condensate or cooling liquid, of the containment 4 may take place, as indicated in FIG. 4.

Furthermore, FIG. 4 also indicates an alternative or additional measure to the conveying blower 18, to be precise what is known as a steam ejector 180 which in the manner of a jet pump utilizes the Venturi effect of a convergent/divergent nozzle, in order to convert the energy contained in a pressurized drive fluid, here steam, into the propulsion and compression of the gas stream in the recirculation line 128 which is at the same time sucked in in the nozzle and entrained. The steam ejector 180 is driven, for example, by passively generated steam as a result of the pressure expansion of a hot water boiler 182, and in this case the heating of this boiler may be brought about, in turn, recuperatively by process heat which occurs. All the measures are aimed at largely passive containment cooling and inertising.

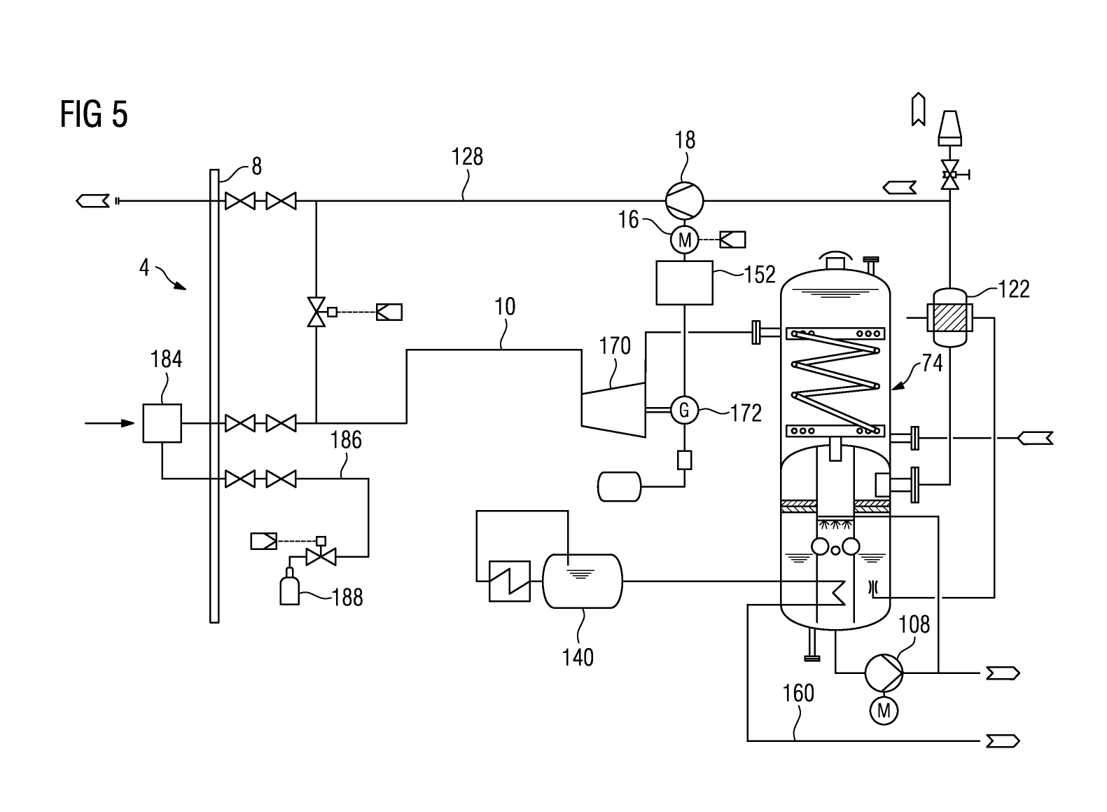

Finally, in the variant illustrated in FIG. 5 and linked to FIG. 3, instead of a recombination device 20 arranged outside the containment 4, an internal recombination device 184 arranged inside the containment 4 is adopted for hydrogen breakdown, for example also in combination with a likewise internal cooling stage and/or internal filter unit. The internal recombination device 184 may, in particular, be of the type described in the German patent application 10 2012 211 897.7, filed on 9 Jul. 2012 by AREVA NP GmbH. The content of this application is hereby declared to be an integral part of the present description and is hereby incorporated by reference herein.

If necessary, especially when there is an oxygen deficiency in the containment 4, the internal recombination device 184 may be supplied with oxygen O₂ from outside. For this purpose, it is necessary to have a further line which is routed through the safety containment 8 and can be closed by means of a shut-off valve and which can be used as an oxygen supply line 186. For this purpose, the external connection of this line is connected to an oxygen bottle 188 or the like. The internal end of this line is expediently located in the more immediate inflow region of the recombination device 184 or directly at the reaction zone.

The following is a summary list of reference numerals and the corresponding structure used in the above description of the invention:

| | |
|---|---|
| 2 | Containment protection system |
| 4 | Containment |
| 6 | Nuclear facility |
| 8 | Safety containment |
| 10 | Supply line |
| 12 | Shut-off valve |
| 14 | Outflow line |
| 16 | Drive motor |
| 18 | conveying blower |
| 20 | recombination device |
| 22 | Line section |
| 24 | Venturi tube |
| 26 | Pre-heater |
| 28 | Line |
| 30 | Inlet connection piece |
| 32 | Reaction chamber |
| 34 | First reaction zone |
| 36 | Carrier element |
| 38 | Interspace |
| 40 | Heating element |
| 42 | Second reaction zone |
| 44 | Surrounding wall |
| 46 | Third reaction zone |
| 48 | Annular region |
| 50 | Surrounding wall |
| 52 | Flow duct |
| 54 | Outlet connection piece |
| 56 | Heat exchanger |
| 58 | Heat exchanger |
| 60 | Cooling zone |
| 62 | Recirculation line |
| 64 | Oxygen bottle |
| 66 | Regulating valve |
| 68 | Connecting line |
| 70 | Spray-in device |
| 72 | Line |
| 74 | Condensation device |
| 76 | Cooling liquid |
| 78 | Ring cooler |
| 80 | Inlet header |
| 82 | Outlet header |
| 84 | Spiral tube |
| 86 | Fresh water connection |
| 88 | Cooling liquid container |
| 90 | Steam outlet |
| 91 | Cooling device |
| 92 | Condensation container |
| 94 | Condensate |
| 96 | Heat exchanger |
| 98 | Inlet region |
| 100 | Flow duct |
| 102 | Contraction |
| 104 | Spray-in device |
| 106 | Condensate extracting line |
| 108 | Condensate pump |
| 110 | Condensate return line |
| 112 | Line |
| 114 | Line |
| 116 | Gas collecting space |
| 118 | Filter element |
| 120 | Line |
| 122 | Molecular screen |
| 124 | Line |
| 126 | Line |
| 128 | Recirculation line |
| 130 | Shut-off valve |
| 132 | Chimney |
| 134 | Outflow line |
| 136 | Shut-off valve |
| 138 | Connecting line |
| 140 | Reservoir |
| 142 | Line |
| 144 | Line |
| 146 | Line |
| 148 | Line |
| 150 | Power supply unit |
| 152 | Battery |
| 154 | Charging unit |
| 156 | Internal combustion engine |
| 158 | Generator |
| 160 | Feed line |
| 162 | Leadthrough |
| 164 | Connection piece |
| 166 | Condensation chamber |
| 168 | Reactor pressure vessel |
| 170 | Steam turbine |
| 172 | Generator |
| 174 | Gas engine |
| 176 | Spraying device |
| 178 | Sump |
| 180 | Steam ejector |
| 182 | Hot water boiler |
| 184 | Recombination device |
| 186 | Oxygen supply line |
| 188 | Oxygen bottle |
| D | Detail |
| H₂ | Hydrogen |
| H₂O | Water (or steam) |
| N₂ | Nitrogen |
| O₂ | Oxygen |

1. A containment protection system for treating an atmosphere disposed in a containment of a nuclear facility in an event of critical incidents with an extensive release of hydrogen and steam, the containment protection system comprising:
a line system for connecting to the containment and forming a circuit out of the containment and back again for a fluid stream;
a recombination device for recombining the hydrogen contained in the fluid stream with oxygen into steam, said recombination device disposed in said line system;
a condensation device disposed downstream of said recombination device, said condensation device condensing steam fractions contained in the fluid stream, said condensation device having means for discharging condensate from the fluid stream;
a drive for propelling the fluid stream;
a reservoir for an inert gas;
a supply line; and
a heat exchanger for at least partial recooling of said condensation device, said heat exchanger having an inlet side connected via said supply line to said reservoir for the inert gas effective as a coolant.

2. The containment protection system according to claim 1, wherein said heat exchanger is an inert gas evaporator.

3. The containment protection system according to claim 1, further comprising a feed line, said heat exchanger having an outlet side connected via said feed line to the containment, so that the inert gas, supplied for recooling said condensation device can subsequently be used for inertising the containment.

4. The containment protection system according to claim 1, wherein said recombination device has a plurality of catalytic reaction zones flow-connected in series.

5. The containment protection system according to claim 4, further comprising electric heating elements, wherein at least one of said catalytic reaction zones being heatable by said electric heating elements.

6. The containment protection system according to claim 5, wherein said at least one catalytic reaction zone being electrically heated contains a plurality of catalytically coated carrier elements, in each case of annular cross-section, which are disposed concentrically about a common longitudinal axis and are spaced apart from one another by flow-carrying interspaces.

7. The containment protection system according to claim 1, further comprising a Venturi tube, wherein said recombination device being preceded in flow by said Venturi tube which accelerates the fluid stream to flow velocities of 10 to 160 m/s.

8. The containment protection system according to claim 1,
wherein said recombination device has an oxygen supply line; and
further comprising a further reservoir for oxygen which can be supplied via said oxygen supply line of said recombination device.

9. The containment protection system according to claim 1, further comprising a recirculation line, by means of said recirculation line a part stream of the fluid stream leaving said recombination device on an outlet side can be returned to an inlet side of said recombination device.

10. The containment protection system according to claim 1, wherein said condensation device having a cooling device and a condensation container which is preceded by said cooling device for the fluid stream, said cooling device being configured for recooling by evaporation of a cooling liquid.

11. The containment protection system according to claim 1, further comprising a wet scrubber unit for the fluid stream being integrated into said condensation device.

12. The containment protection system according to claim 11, wherein said wet scrubber unit being such that radioactive particles and aerosols contained in the fluid stream are separated in the condensate.

13. The containment protection system according to claim 1, further comprising a dry filter unit for the fluid stream disposed downstream of said condensation device.

14. The containment protection system according to claim 1, further comprising:
a shut-off valve; and
an outflow line closeable by means of said shut-off valve and disposed downstream of said condensation device for emergency venting of the fluid stream into the surroundings.

15. The containment protection system according to claim 1,
further comprising a condensate return line;
further comprising a condensate pump; and
wherein said condensation device has a condensation container for collecting the condensate, said condensation container is connected to the containment via said condensate return line, into which said condensate pump is connected.

16. The containment protection system according to claim 1, wherein said drive for the fluid stream is an electrically driven conveying blower.

17. The containment protection system according to claim 1, wherein said drive for the fluid stream is a conveying blower driven by means of an expansion of the inert gas out of said reservoir.

18. The containment protection system according to claim 1,
further comprising a recuperatively heated hot water boiler; and
wherein said drive for the fluid stream is a steam ejector being driven by steam from said recuperatively heated hot water boiler.

19. The containment protection system according to claim 18, wherein said drive for the fluid stream being connected into said line system upstream of said recombination device or downstream of said condensation device.

20. The containment protection system according to claim 1, further comprising a steam turbine driven by the fluid stream being connected between said recombination device and said condensation device and driving a generator for generating electrical energy required for operating the containment protection system.

21. The containment protection system according to claim 1, wherein at least one of said condensation device or said recombination device is disposed outside the containment.

22. The containment protection system according to claim 1, wherein the containment protection system is of a modular standard container type of construction.

23. The containment protection system according to claim 13, wherein said dry filter unit is a recuperatively heated molecular screen.

24. A method for operating a containment protection system according to claim 1, which comprises the step of:
recircultaing at least one of the fluid stream or the condensate completely into the containment, and no emission into the surroundings takes place.

25. The method according to claim 24, which further comprises conducting the inert gas evaporated during the recooling of the condensation device and further components of the containment protection system at least partially for inertising into the containment and/or a reactor building.
